(19) United States
(12) Patent Application Publication
(10) Pub. No.: US 2017/0157434 A1
(43) Pub. Date: Jun. 8, 2017

(54) DOOR BREACHING DEVICE

(71) Applicant: Ivan Henrik STÅHL, Malmö (SE)

(72) Inventor: Ivan Henrik STÅHL, Malmö (SE)

(21) Appl. No.: 15/324,225

(22) PCT Filed: Jul. 2, 2015
(86) PCT No.: PCT/SE2015/050781

§ 371 Date: Jan. 5, 2017

(30) Foreign Application Priority Data
Jul. 7, 2014 (SE) 1450873-3

(51) Int. Cl. A62B 3/00

(52) U.S. Cl. CPC A62B 3/005; A62B 3/00

(57) ABSTRACT

The present invention describes a device (1) intended for door breaching, wherein the device (1) comprises a breaching unit (2) and an inner charge container (3) intended to hold a charge unit, said charge unit comprising an ignitable pyrotechnic material, and wherein the device (1) also comprises an outer container (6) enclosing the inner charge container (3).

### FIELD OF THE INVENTION

The present invention relates to a device intended for door breaching.

### TECHNICAL BACKGROUND

There are existing devices for door breaching. For example, in U.S. Pat. No. 5,769,394 there is disclosed a method and apparatus for force-opening doors. An anchoring unit carrying a ram unit having a ram member is aligned with a side of a door frame. The anchoring unit is anchored to the door by moving a pair of clamping members towards each other into clamping engagement with the opposite sides of the door. The clamping members are moved towards each other by a force-multiplying device, preferably hydraulic device involving the use of a pressurised fluid such as oil as the hydraulic fluid. Once anchored to the door, the ram member is driven outwardly of the ram unit by a force-multiplying device, against the side of the door frame to force-open the door. The ram unit includes an abutting member positionable to abut against the inside face of the door facing the ram unit, to assist in force-opening the door when the ram member is driven against the door frame. Moreover, in US 2004/0149969 and US 2012/0119174 there are also disclosed devices for exerting thrust on a door by use of a pressurised fluid exerting a hydraulic force on the door.

There is a need for an improved door breaching device which has an increased breaching effect in comparison to the existing devices. One aim of the present invention is to provide such a device with increased breaching effect and which device still is easy and fast to use.

### SUMMARY OF THE INVENTION

The stated purpose above is achieved by a device intended for door breaching, wherein the device comprises a breaching unit and an inner charge container intended to hold a charge unit, said charge unit comprising an ignitable pyrotechnic material, and wherein the device also comprises an outer container enclosing the inner charge container.

As understood from above, the present invention is directed to use of an ignitable pyrotechnic material. A pyrotechnical material according to the present invention is not an explosive, not even when the material is exposed to stress or the like. The pyrotechnical material, i.e. composition, substance or the like, may suitably be ignited electrically via a connected electric cable. Also a wireless set-up is possible to use. The use of an ignitable pyrotechnic material in a device according to the present invention could also be addressed as exerting pyrotechnical hydraulic. Furthermore, it may also be mentioned that the present invention involves deflagration during use.

The “outer container” of the device according to the present invention provides an enclosing and expansion vessel for the fumes formed after ignition during the blast. As seen in the figures, the outer container of the present invention may be of different type depending on the type of embodiment.

In NL 2005085 C there is disclosed a device for exerting an impact force to an access element, such as a door or a window, of a substantially closed space, said device comprising a driving element for exerting the impact force on the access element, which driving element is provided with a housing and an in the housing displaceably prepared thrust member. The device is an elongated assembly which is arranged for applying a clamping in the proximity of the access element, where the assembly is provided with first coupling members and wherein the driving element provided with the first coupling element is co-operating second coupling elements for the coupling of the driving element to the assembly. The driving effect of the pyrotechnic element can be obtained by use of for example at least two substances which are brought together to cause an exothermic reaction in which gases may be formed which occupy a larger volume than the volume of the drive element. In a practical embodiment it is mentioned that the materials include a substance which is selected from sodium azide (NaN₃) and a combination of nitroguanidine, phase-stabilized ammonium nitrate (NH₄NO₃), or other non-metallic oxidizing agent, and a nitrogen-rich fuel other than azide. Furthermore, in NL 2005085 C there is mentioned that the housing 5 may comprise a pyrotechnic element of a first type that has a fuel for an exothermic chemical reaction. Examples mentioned are potassium perchlorate and potassium chlorate. Moreover, it is stated that in general the blends decompose very rapidly and that they can ignite spontaneously. Furthermore, in another specific embodiment, the housing 5 comprises a pyrotechnic element of a second type that makes use of materials which are classified as primary or secondary explosives so a very fast and powerful mechanical effect to obtain.

As notable from above, the solution disclosed in NL 2005085 C is directed to obtaining a chemical exothermic reaction which in turn provides for an explosive effect. Furthermore, the pyrotechnic element are provided next to the pressing thrust member.

The present invention, however, is directed to a device comprising an inner charge container with the charge unit and an outer container enclosing the inner charge container. This enclosure brings about several advantages. The user may be closer to the device and door during use of the device. Dangerous fumes, smoke and fire will not flow freely out into the space around the device. Moreover, this does not only prevent a dangerous handling. If smoke was allowed to flow freely out into the space around the device, the visibility will be decreased when used in e.g. a closed space like a stairwell. Time is extremely crucial when breaching doors. A police special forces unit or the like using the device must be able to quickly enter an apartment after breaching a door of the same.

There are also other clear differences between the present invention and the device disclosed in NL 2005085 C. This will be clear from several embodiments shown in the figures.

### BRIEF DESCRIPTION OF THE DRAWINGS

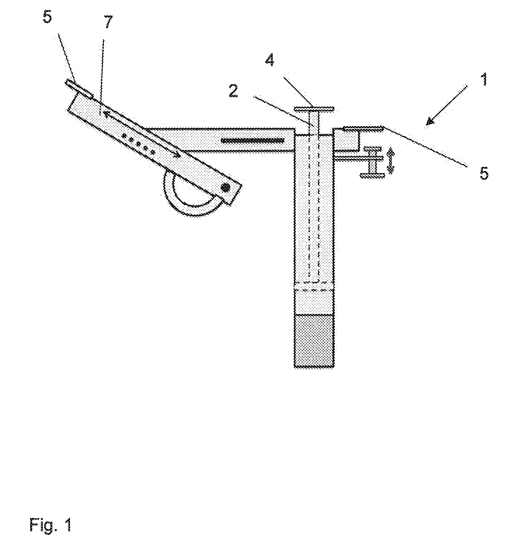

In FIG. 1 there is shown one specific embodiment of the device according to the present invention.

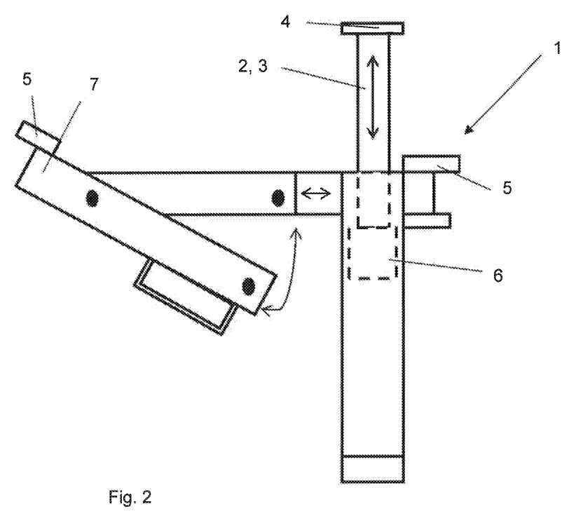

In FIG. 2 there is shown another specific embodiment of the device according to the present invention, similar to the one shown in FIG. 1.

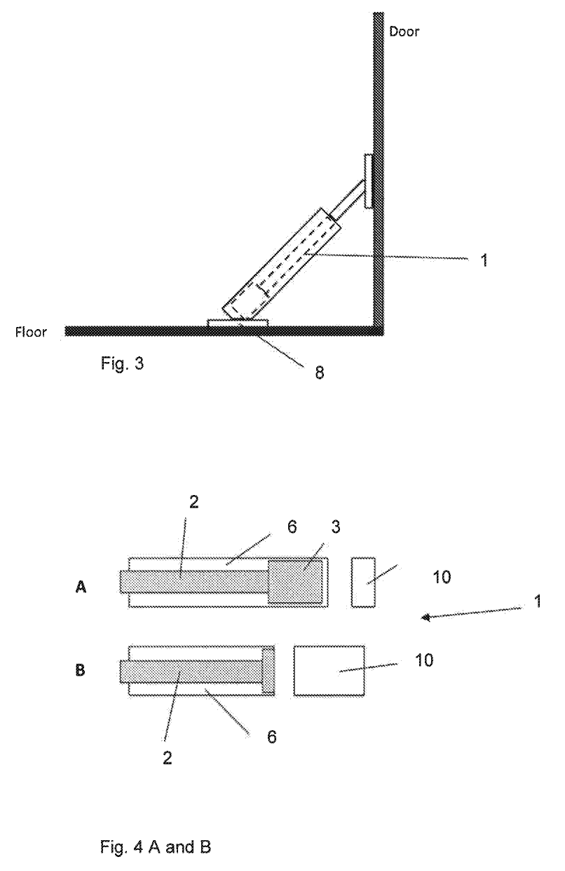

In FIG. 3 there is shown one specific embodiment of the present invention, when the device is fastened against the floor and the door to breach.

In FIG. 4 A and B there are shown two different embodiments of the present invention. These show a possible difference in how to incorporate lids in the arrangement.

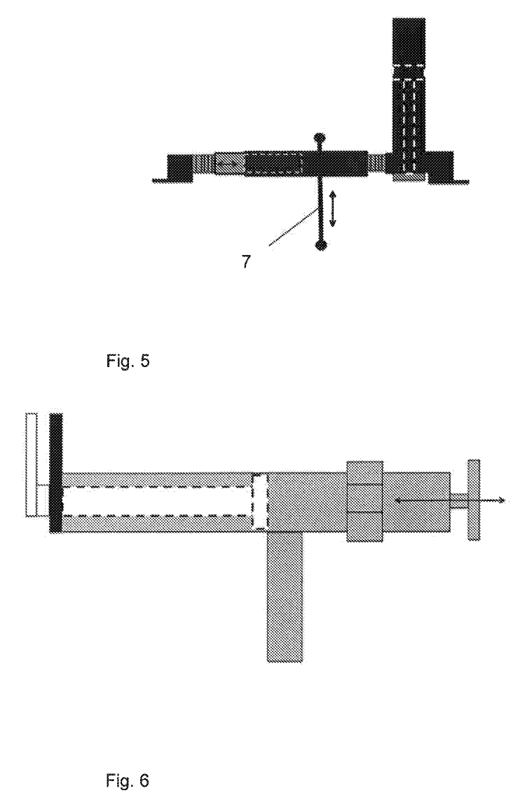

In FIG. 5 there is shown yet another embodiment of the present invention, in this case intended for breaching a door that either opens inwards (into the room) or outwards.

In FIG. 6 there is shown a handheld device according to one embodiment of the present invention.

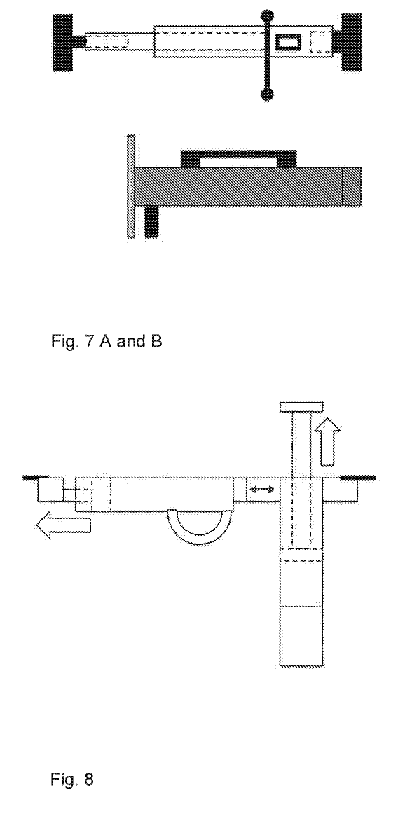

In FIG. 7 A and B there are shown one embodiment of the present invention, where FIG. 7 A shows the device just before use and FIG. 7 B shows a part intended to be fixated into FIG. 7 A.

In FIG. 8 there is shown yet another embodiment of the present invention.

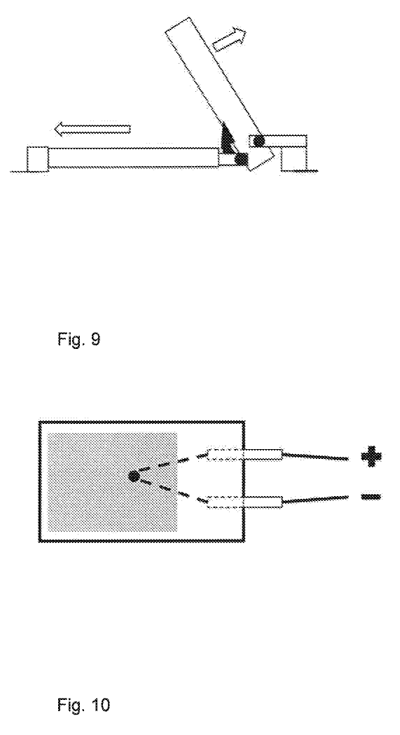

In FIG. 9 there is shown one embodiment of the present invention.

In FIG. 10 there is shown a view on an ignition unit according to possible embodiments of the present invention.

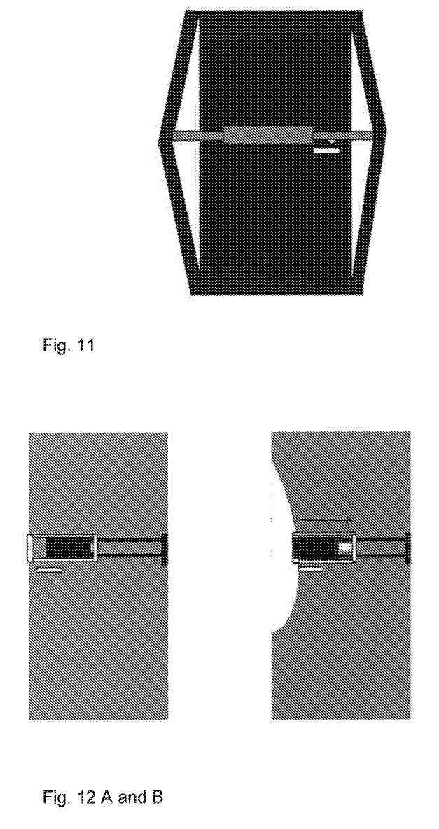

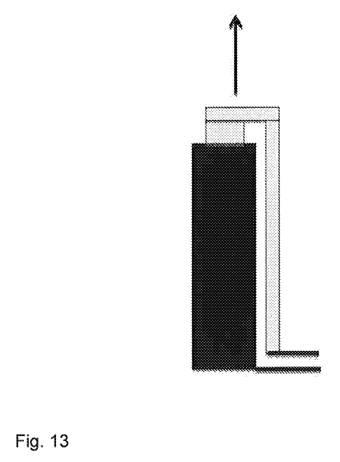

In FIG. 11 and FIG. 12 A and B there are shown views on possible modes of breaching doors with a device according to the present invention.

In FIG. 13 there is shown yet another embodiment of the present invention.

### SPECIFIC EMBODIMENTS OF THE INVENTION

Below, some specific embodiments of the present invention are disclosed.

According to one specific embodiment of the present invention, the outer container provides a seal of the inner charge container. As said above, regardless of there is a total seal or not, the outer container provides an enclosure of the charge container.

The actual connection between the breaching unit and inner charge container and outer container may vary according to the present invention. According to one specific embodiment of the present invention, the breaching unit comprises the inner charge container. Such an alternative is shown in FIG. 2.

According to one embodiment of the present invention, the outer container is enclosing at least part of the breaching unit before activation. This may be seen in several of the figures. Examples are FIGS. 2 and 5 A and B. It may also be mentioned that the expression “before activation” in this case implies before the ignition and deflagration.

The pyrotechnical material, such as e.g. zincite being discussed more below, may be arranged in a paper case. The ignition wire is connected with the pyrotechnical material from the outside and into the paper case. The paper case may either be arranged freely against the outer container in front of a plate or is provided in an inner container with a closed side. In the latter case all is arranged in the outer container. These alternatives are shown in FIG. 4 A and B.

According to yet another embodiment of the present invention, the device also comprises a lid intended as a protection of an end of the outer container, wherein the inner charge container and hence charge unit is arranged at the end of the outer container before activation. Such an alternative of the present invention is shown in FIG. 5 A.

In yet another embodiment, the device comprises an outer container enclosing part of a breaching unit and a plate being one end of the breaching unit and positioned at one end of the outer container, said device also comprising a lid with a charge unit comprising an ignitable pyrotechnic material, wherein the lid and charge unit is in contact with the outer container and hence plate before activation. Such an alternative is shown in FIG. 5 B of the drawings. It should be noted that these plate, which may be called an end plate, is not the same as the pressure plate discussed below.

According to one embodiment, the breaching unit comprises a pressure plate which is connectable to the inner charge container. The pressure plate provides pressure area to further ensure that an entire door is breached and not part of a door.

According to yet another specific embodiment, the device has means for fixating the device into a door case and as such the pressure plate against a door case. Such a door case (frame) is normally made of steel. One example of means for fixating is shown in FIG. 2, another one is shown in e.g. FIG. 9. The fixating means locks into the door case frame, and as such a pressure hold-up is provided. When the pyrotechnic material is ignited and the pressure force is exerted a hold-up is needed so that the power of the exerted force is not directed out into the space outside of the door, but instead against the door to breach the same. This pressure hold-up may be provided by a fixation of the device into the door case. This hold-up may, however, also be provided by other means, complementary or stand-alone solutions. Furthermore, the hold-up disclosed above created only by fixating the device into the door case frame is possible for doors that open inwards. For doors that open outwards, this is not possible.

When the pyrotechnical material ignites, fumes are formed. The expansion of these fumes, also creating the pressure force, has to be controlled, at least during a first short time after the blast. As mentioned the device also comprises an outer container. The outer container of the device functions as the expansion vessel for the fumes formed after ignition during the blast.

One part of the control may be directed to ensure that the fumes are not freely flown out into the space behind the device. As seen in inter alia FIG. 2, the actual tube comprising the inner charge container and outer container are quite large and long. As such there is enough space for the fumes to expand out into after the blast.

Moreover, at the end of the tube comprising the inner charge container and outer container there may be provided a valve. This valve may allow for an electric wire or cable to enter into the tube and reach the charge, but at the same time function as a closing device after the blast so that the fumes are not freely flown out into the space behind the device. The valve may e.g. be a flap valve or a clack valve. Instead of valves a small hole or slot may also function as the opening to receive the electrical cable.

It should further be said that the actual ignition mechanism may also be wireless so that the entire tube can be rigidly enclosed without any openings or the like for an electrical cable.

As probably understood, the device must be fixated against the door to breach the same. According to one embodiment, relating to the doors that open inwards, this fixation is created by a fixation of the device into the door frame of the door. Furthermore, the device may comprise other means for ensuring a better fixation and increasing the ease for the user to fixate the device. According to one specific embodiment of the present invention, the device also comprises a lever which enables to tighten the device against a door. This lever may further be divided into different parts, for instance consisting of one pivotable part, where one or more joints create this pivotable feature. Such pivotable design may further increase the easiness to fixate the device into the door frame tightly.

It should further be said that pressure hold-ups may be created by other means according to the present invention than disclosed above, either as a complement or as a stand-alone solution. According to one specific embodiment, the device comprises a floor fixating unit. One example thereof may be seen in. FIG. 3. As the device is placed with the breaching unit comprising the inner charge container in an angled direction out from the door, the hold-up may be created by the breaching unit and a floor fixating unit as a locking unit, i.e. without any door case fixating means. In such a case, then the floor fixating unit may in fact only comprise a plate which provides both weight and area in the bottom of the device to increase the stability of the device and further ensure the hold-up feature. This form of pressure hold-up according to the present invention is possible to use for both doors that opens inwards and outwards.

As mentioned above, the floor fixating unit may in fact only comprise a plate to be placed onto the floor. As long as a rigid and stabile structure is possible to achieve when the device is placed with its door pressure plate against the door to breach and with the bottom plate against the floor, no further fastening or anchoring is a must. However, the floor fixating unit may according to the present invention also comprise some form of fastening means so that the unit may be anchored to the floor or elsewhere, the latter e.g. via other means or units.

According to yet another specific embodiment, the device comprises one or more wheels. According to one embodiment, the device comprises at least one pair of wheels, i.e. with a design e.g. as a carry-on case/bag. This may be of interest to increase the ease of transporting the device quickly to the door intended to be breached. A pair of wheels or even more wheels may further increase the user-friendliness of the device. As the device should be made of materials which are strong enough for the use, e.g. metals, such as stainless steel or the like, the device is of considerable weight, and means to simplify the transport from one point to another may be of interest to include in the device according to the present invention. Other such means may be a grip or handle to carry or bring along the device. Such a grip or handle is a typical means to combine with a bag design of the device according to the present invention, said bag design also having a pair of wheels or more.

Furthermore, the bag design of the present invention may be a typical set-up to use when both doors that open outwards and inwards may be of interest to breach. As such, the embodiment and design of the present invention shown in FIG. 3 is a typical form to include or hold in a bag. As an example, when the bag is rolled up to the door, both the breaching unit and floor plate or the like is possible to pull or fold out from the bag. This may be possible by incorporating e.g. joint features in the device.

The material of the actual device may vary, and different metals, such as stainless steel, are one example to use.

Furthermore, also the material, composition or substance in the pyrotechnical material may vary. According to one specific embodiment of the present invention, the ignitable pyrotechnic material comprises zincite (“zinkit” in Swedish). In this context “zincite” refers to the pyrotechnical material, also used as rocket fuel, consisting of 25% sulphur and 75% zinc (zinc dust). The chemical reaction does not need any oxygen and as such zincite is very suitable as an emergency fuel out in space where no oxygen exists.

Also in relation to this specific embodiment of the present invention it may further be stated that zincite and its advantages in this context are not at all disclosed or hinted in NL 2005085.

Advantages with zincite relate to the fact that zincite is not sensitive to vibration and may be transported, such as in a car, and handled at its place of use safely. Moreover, zincite may be used under water as it does not need oxygen to burn. Therefore, this substance is also preferable to use in sub-water applications.

Moreover, the suitable amount of the charge of ignitable pyrotechnic material varies and depends on inter alia the concentration of the active substance.

It should further be said that a device according to the present invention may find other use than only for breaching operations. One example is in the film industry for creating effects, such as for flipping a car or bus or the like when the device is being placed beneath the same and blasted from there.

Moreover, the device according to the present invention may also be used in underwater operations. Therefore, according to one specific embodiment, at least the inner charge container with the charge unit is submersible, for underwater use. Moreover, the charge unit may also be protected against outer type of influence, such as against heat or the like.

The device may be one part of a kit which comprises other units. Examples of such units are cutter, spreader and lift, were all these specific examples may be of interest for divers performing underwater operations. It should further be said that also other kinds of additional units may be of interest, also for the door breaching operations.

### DETAILED DESCRIPTION OF THE DRAWINGS

In FIG. 1 there is shown one embodiment of the present invention. The device 1 has a breaching unit 2. The device 1 has a pressure plate 4 which is the part pressing on the door. Moreover, the device includes means 5 for fixating the device into a door case (frame) and a lever 7 which enables to tighten the device 1 against a door. Furthermore, the device 1 also comprises a screw clamp which holds around the door frame and as holds the device 1 in place during use. The screw clamp is depicted together with arrows showing the possibility of tightening the fixation. The screw clamp provides for extra security. Otherwise, the embodiment shown is very similar to the one disclosed in FIG. 2 and further discussed below.

In FIG. 2 there is shown a device 1 having a breaching unit 2 comprising an inner charge container 3 intended to hold a charge unit with an ignitable pyrotechnic material. The inner charge container 3 functions as a breaching arm after ignition of the ignitable pyrotechnic material. In this case the inner charge container 3 is shown in an extended condition, which of course is not the starting position before breaching a door. This extension feature is visualized by the shown double arrow of the inner charge container 3. It should be noted that the inner charge container in this case is an axle/bar and will not contain fumes after ignition. The pressure forms when it is expanded against the pressure plate 4. Therefore the pressure plate 4 is connected to the inner charge container 3, and the pressure plate 4 is the part pressing on the door. This is different when comparing to the embodiments shown in FIG. 4 A and B discussed below.

Moreover, in the embodiment shorn in FIG. 2 the device 1 has means 5 for fixating the pressure plate 4 to a door. The means 5 for fixating is fixated into a door case (frame). This fixation may also provide the hold-up needed to breach the door, at least for doors that opens inwards. This hold-up may, however, also be provided by other means, such as also shown in FIG. 2 and explained below.

An outer container 6 of the device functions as the expansion vessel for the fumes formed after ignition, i.e. during the blast. At the end of the tube comprising the outer container 6 there may be provided a valve.

Furthermore, according to this embodiment there is a lever 7 which enables to tighten the device 1 against a door. In this case this is created by providing one part with at least one joint. Furthermore, the lever or door-longitudinal arm of the device may be extendible to fit different door cases and also to ensure a tighter fastening into a door case. This is visualized by the double arrows of the door-longitudinal arm of the device 1.

In FIG. 3 there is shown one specific embodiment of a device 1 according to the present invention. In this case the device 1 comprises a floor fixating unit 8, which also may create the needed pressure hold-up before breaching by locking the breaching unit against the door in an angle. With such a hold-up and design both doors that open inwards and outwards are possible to breach. In relation to this design according to the present invention it may also be mentioned that the device 1 may be provided with one or more wheels, e.g. as a carry-on case/bag. This may be of interest to increase the ease of transporting the device 1 quickly to the door intended to be breached. As seconds may be critical when one is about to perform breaching operations, all features increasing the ease of taking the device to the door may be of interest.

In FIG. 4 A and B there are shown two different embodiments of the present invention. These show a possible difference in how to incorporate lids 10 in the arrangement according to the present invention. The charge may be provided in the lid 10 when having a configuration such as the one shown in FIG. 4 B. The lid 10 is connected with outer container 6 and plate enclosed therein when intended to be used. In FIG. 4 A the outer container 6 encloses an inner charge container 3 holding the charge unit already before being connected to the lid 10.

In FIG. 5 there is shown yet another embodiment of the present invention. In this case the device 1 may comprise several units which are connected to each other, such as for instance by threaded connections. Moreover, the device may also be adjustable in length which is shown with the arrows in the device 1. Moreover, there is also shown a different form of lever 7 which in this case also functions as a screw clamp (see the arrows outside of part 7).

In FIG. 6 there is shown a handheld device 1 according to one embodiment of the present invention. This embodiment is a device 1 intended for breaching both doors that opens inwards (into the room) and outwards, especially wooden inner or outer doors. By directing the force (the piston) against the lock box of the door, the door may be breached. As the lock box is of metal and the door of wood, the lock plunger positioned in the lock box and into the door case may be forced out of position and the door may be breached. According to the embodiment shown in FIG. 6, a unit is arranged which pushes the bolt out of its position by separating the door blade and door frame enough.

In FIG. 7 A and B there are shown one embodiment of the present invention, where FIG. 7 A shows the device just before use and FIG. 7 B shows the device in a “carry around” unit before use. The “hold-up” part, shown on the left side, is first fixated into the device 1, then the charge unit is connected into the device 2 (see on the right side). Also in this case there is a lever stick provided on the device 1, said lever stick being of the type as on a screw vice. The device shown in 7 A is fixated against the door and the unit shown in FIG. 7 B is fixated into the device shown in FIG. 7 A.

In FIG. 8 there is shown yet another embodiment of the present invention. In this case the device 1 is provided with at least one chamber part also in the door-longitudinal arm so that also an extension of this arm is provided when the fumes expand after ignition. This may be of interest to increase the anchoring of the device 1 into a door case, and as such the pressure hold-up, so that it is only the actual door that is breached and not the door as well as the door case. The latter could occur if the door case frame is not tightly anchored into the wall, and may cause problems during breaching operations and also increase the damages caused. Furthermore, the device 1 according to this embodiment may also comprise two charge units, one being directed towards the frame and one directly towards the door.

In FIG. 9 there is shown one embodiment of the present invention. This alternative provides an arrangement with a combination of hydraulic jack and hydraulic pyrotechnical force. The pipe enclosing the pyrotechnical material, such as e.g. zincite, is used as a lever to hydraulically pump the device tool 1 so that it is fixated securely against the door frame. Based on what has been disclosed above and shown in FIG. 9, according to one specific embodiment of the present invention, the lever 7 has at least one joint enabling rotation or hydraulic pumping.

In FIG. 10 there is shown a views on an ignition unit according to possible embodiments of the present invention. In FIG. 10 there is shown how the charge may be ignited. The conductor enables currency to be transported from a battery through a sealed steel material/unit to an ignition thread in contact with the pyrotechnical material without having the risk of a short circuit, and without the risk of dangerous fumes and fire coming out freely into the space close to the door and user. By use of a fibre washer, connection unit and nut in the same configuration on both sides of the steel material the risk of short circuits is avoided. As such this embodiment of the present invention secures that the conductor, suitable of steel, does not come into contact with the lid also being made of steel. Moreover, it may also be mentioned that this entire configuration is also different from the device disclosed in NL 2005085 C.

In FIG. 11 and FIG. 12 A and B there are shown views on possible modes of breaching doors with a device according to the present invention. As seen in FIG. 11, then this embodiment of the present invention enables a device 1 to push against the long sides of both door frames to separate the door from the door frame. As mentioned above, other configurations of the present invention provides a push on both the door in itself as well as against both door frames. Moreover, in FIG. 12 there is shown one embodiment of the present invention and how such a device 1 enables the door to be crumpled up and detached from the frame.

In FIG. 13 there is shown yet another embodiment of the present invention. This device 1 is intended for doors being opened in an outwards direction. In this context it may also be mentioned that also the handheld embodiment of the present invention is functional on both doors to be opened outwards and inwards. The device 1 shown in FIG. 13 is pushed inside beneath the lower edge of the door. When the device 1 is being used (ignited), the force lifts up the door out of the hinges and the frame.

1.-13. (canceled)

14. Device intended for door breaching, wherein the device comprises a breaching unit and an inner charge container intended to hold a charge unit, said charge unit comprising an ignitable pyrotechnic material, and wherein the device also comprises an outer container enclosing the inner charge container.

15. Device according to claim 14, wherein the outer container provides a seal of the inner charge container.

16. Device according to claim 14, wherein the breaching unit comprises the inner charge container.

17. Device according to claim 14, wherein the outer container is enclosing at least part of the breaching unit before activation.

18. Device according to claim 14, wherein the device also comprises a lid intended as a protection of an end of the outer container, wherein the inner charge container and hence charge unit is arranged at the end of the outer container before activation.

19. Device according to claim 14, wherein the breaching unit comprises a pressure plate which is connectable to the inner charge container.

20. Device according to claim 14, wherein the device has means for fixating the device into a door case.

21. Device according to claim 14, wherein the device also comprises a lever which enables to tighten the device against a door.

22. Device according to claim 21, wherein the lever has at least one joint enabling rotation or hydraulic pumping.

23. Device according to claim 14, wherein the device comprises a floor fixating unit.

24. Device according to claim 14, wherein the device comprises one or more wheels.

25. Device according to claim 14, wherein the ignitable pyrotechnic material comprises or is zincite.

26. Device intended for door breaching, wherein the device comprises an outer container enclosing part of a breaching unit and a plate being one end of the breaching unit and positioned at one end of the outer container, said device also comprising a lid with a charge unit comprising an ignitable pyrotechnic material, wherein the lid and charge unit is in contact with the outer container and hence plate before activation.

27. Device according to claim 26, wherein the breaching unit comprises a pressure plate which is connectable to the inner charge container.

28. Device according to claim 26, wherein the device has means for fixating the device into a door case.

29. Device according to claim 26, wherein the device also comprises a lever which enables to tighten the device against a door.

30. Device according to claim 29, wherein the lever has at least one joint enabling rotation or hydraulic pumping.

31. Device according to claim 26, wherein the device comprises a floor fixating unit.

32. Device according to claim 26, wherein the device comprises one or more wheels.

33. Device according to claim 26, wherein the ignitable pyrotechnic material comprises or is zincite.
